(19) United States
(12) Patent Application Publication
(10) Pub. No.: US 2022/0389259 A1
(43) Pub. Date: Dec. 8, 2022

(54) ECO-FRIENDLY CRAYON COMPOSITION AND METHOD FOR PRODUCING ECO-FRIENDLY CRAYONS

(71) Applicants: Katie Gill-Harvey, Baltimore, MD (US); Sabrina Rosenberg, Lake Worth, FL (US)

(72) Inventors: Katie Gill-Harvey, Baltimore, MD (US); Sabrina Rosenberg, Lake Worth, FL (US)

(21) Appl. No.: 17/338,279

(22) Filed: Jun. 3, 2021

(51) Int. Cl. C09D 13/00; B29C 39/00; B29C 39/02

(52) U.S. Cl. CPC C09D 13/00; B29C 39/003; B29C 39/02; B29K 2091/00

(57) ABSTRACT

A composition for eco-friendly crayon and a method for producing the eco-friendly crayon is disclosed. The composition comprises one or more non-toxic ingredients including soy wax, beeswax, and coloring pigment. The waxes are combined and heated in a heating chamber. The mixture is heated to form a halfway melted mixture. The coloring pigment is added to the halfway melted mixture and stirred until fully dissolved. The dissolved mixture is then poured into a mold and cooled. The cooled mixture is removed from the mold to prepare crayons for use. The crayons are made in a variety of shapes and sizes. The non-toxic ingredients are free of harmful components and prevent crayons from remaining in the user's hand. Further, a method used to prepare the non-toxic crayon uses waxes and coloring pigment without any additional ingredients, thereby providing softer crayons with high level of eco-friendly attributes.

### BACKGROUND OF THE INVENTION

Art materials for the entertainment and developmental benefit of children are well-known. For example, drawing and writing materials, such as crayons, are typically given to children to produce artwork and to stimulate the children's creativity and imagination. Crayons are a coloring tool used to draw pictures and are used to draw or paint a desired picture by rubbing it on paper, cardboard, crafting items, or other desired drawing surfaces. Such crayons are usually made of clay, chalk, graphite, a pigment, beeswax, etc., and have a small prism shape or a cylindrical shape.

To contribute to a pleasant user experience for children, crayons must be capable of smooth laydown and high intensity or vibrancy of the colored markings. Crayons must also be sufficiently flexible and resist breakage, such that they can be used by children without snapping, reducing the potential choking hazard of children ingesting small pieces of crayon that have broken off. Other beneficial characteristics are the ability to layer and alter the shade of colored marks during use, the ability to substantially erase the colored marks, and the ability to easily reshape the end of the crayon to create a sharper point for more precise application of color. Crayons are divided into colored crayons and chalk crayons, depending on the usage. Typically, students and children draw pictures using colored wax crayons.

Crayons are prepared using paraffin as the main raw material. In general, crayons are prepared by mixing together one or more petroleum-based waxes such as water-insoluble paraffin, carnauba wax, hydrocarbon waxes, and the like, with fatty acids, in a molten state in a suitable combination in accordance with the quality of crayon required, adding talc to the molten mixture as a structuring agent, adding a pigment to the molten mixture as a colorant, pouring the resulting composition into a specified mold and solidifying the composition by a cooling process.

While these crayons are functional, petroleum-based waxes are derived from non-renewable sources. Crayon manufacturers therefore have sought to use ingredients that are derived from renewable sources, such as natural oils, thereby lessening their reliance on non-renewable oil. This is especially important since waxes are not a major byproduct of oil production, and at times they are in short supply. In addition, by using renewable sources crayon manufacturers appeal to customers who desire environmentally friendly products.

Conventionally, crayons prepared using paraffin sometimes contain harmful components or toxic substances. Therefore, when young children use crayons, the crayons come into contact with the skin, and thus harmful components or toxic substances can be absorbed into the skin. This has been a problem because it causes skin irritation or may have a negative impact on one's health. Children may also be tempted to ingest such crayons due to their appealing colors, leading to complications such as nausea, vomiting, diarrhea, or in severe cases, intestinal obstruction. In addition, a significant drawback related to typical colored pencils and crayons is that when used by children, they often contribute to messy staining and marking of unintended objects, such as carpets, furniture, walls, or clothing. As a result, adults are often hesitant to provide such crayons and colored pencils to children to avoid potential staining of unintended surfaces.

Henceforth, there is a need for eco-friendly, non-toxic crayons free of harmful components. Also, there is a need for non-toxic crayon without any additional ingredients, thereby providing softer crayons with the highest level of eco-friendly attributes as possible.

### SUMMARY OF THE INVENTION

The present invention discloses writing instruments such as crayons. The present invention further discloses a composition for preparing eco-friendly, non-toxic crayons free of harmful components and one that prevents crayons from remaining in the user's hand by using soy and beeswax which are eco-friendly materials. Also, the present invention discloses a method for producing a non-toxic crayon without any additional ingredients, thereby providing softer crayons with the highest level of eco-friendly attributes.

One aspect of the present disclosure is directed to an eco-friendly crayon composition comprising one or more non-toxic ingredients, soy wax, beeswax, and a coloring pigment. In one embodiment, the crayons are made in a variety of shapes and sizes. One aspect of the present disclosure is directed to an eco-friendly crayon comprising a non-toxic composition of claim 1.

Another aspect of the present disclosure is directed to a method of making an eco-friendly crayon, comprising the steps of: (a) combing one or more waxes in a heating chamber to form a wax mixture comprising soy wax and beeswax; (b) melting the mixture on a low heat to form a halfway melted mixture; (c) adding coloring pigment to the halfway melted mixture; (d) stirring the mixture until fully dissolved; (e) pouring the dissolved mixture into a mold; and (f) cooling the mixture in the mold to prepare crayons. In one embodiment, the wax mixture is selected from a group consisting of soy wax and beeswax. In another embodiment, the wax mixture is heated at a low temperature to form the halfway melted mixture for a predefined period of time ranging from about 3 to about 5 minutes. In another embodiment, the dissolved wax is cooled for a period of time ranging from about 10 to about 30 minutes. In a related embodiment, the time required for cooling the dissolved wax depends on the size of the mold. In one embodiment, the crayon is soft and blendable.

Other features and advantages of the present invention will become apparent from the following detailed description. It should be understood, however, that the detailed description and the specific examples, while indicating specific embodiments of the invention, are given by way of illustration only. Various changes and modifications within the spirit and scope of the invention will become apparent to those skilled in the art from this detailed description.

### BRIEF DESCRIPTION OF DRAWINGS

FIG. 1 exemplarily illustrates a composition for producing eco-friendly and non-toxic crayons, according to an embodiment of the present invention; and

FIG. 2 exemplarily illustrates a method for producing the crayons, according to an embodiment of the present invention.

### DETAILED DESCRIPTION

The present invention generally relates to writing instruments such as crayons and more particularly relates to a composition for eco-friendly crayons and a method for producing the same. At present, there is a need for eco-friendly, non-toxic crayons free of harmful components and ones that prevent crayons from remaining on the user's hand. Also, there is a need for non-toxic crayons that do not have any additional ingredients typically found in existing crayons, thereby providing softer crayons that are eco-friendlier and more superior in quality.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Before any embodiments of the invention are explained in detail, it is to be understood that the invention is not limited in its application to the details of construction nor to the arrangement of components set forth in the following description or illustrated in the drawings. The invention is capable of other embodiments and of being practiced or of being carried out in various ways.

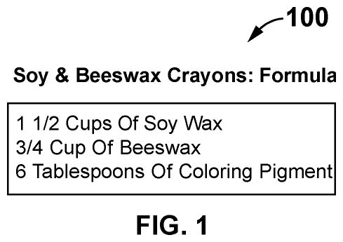

Referring to FIG. 1, a composition 100 is disclosed having one or more non-toxic ingredients to prepare eco-friendly crayons, according to one embodiment of the present invention. In one embodiment, the eco-friendly crayon comprises a non-toxic composition having one or more non-toxic ingredients. In one embodiment, the one or more non-toxic ingredients include one or more waxes and at least one coloring agent. In one embodiment, the one or more waxes include soy wax and beeswax. In one embodiment, the wax mixture enables the crayon to be softer and blendable. In one embodiment, the composition 100 comprises about 1 ½ cups of soy wax. In one embodiment, the soy wax used is Golden soy wax 444. Both white soy pellets and flakes result in a consistency that is too soft and result in poor blendability.

In one embodiment, the composition 100 comprises about ¾ cup of beeswax. The beeswax used, in one example, is white beeswax pellets, as beeswax flakes result in improper melting. In one embodiment, the beeswax pellets used are small beeswax pellets. Large beeswax pellets cannot be used as they melt at a slower rate than the soy wax, resulting in the soy wax reaching a temperature over 185 degrees and the pigment separating from the wax. This ratio must be exact to produce optimal blendability, softness, and color deposit.

If the mixture is not exact the consistency of the crayon will not hold. After various testing, this mixture was the most optimal consistency to provide a blendable, soft, pastel like crayon. A crayon made from solely soy wax becomes too soft and was discovered by the inventor of the instant disclosure to fail to deposit pigment on paper to an acceptable level. A crayon made solely from beeswax was discovered by the inventor of the instant disclosure to render the crayon too hard and fail to hold pigment well. A 1:1 ratio of soy and beeswax creates a crayon that is too soft and does not deposit strong pigment on paper. Without the discovery of the disclosed blend of the soy and beeswax, the consistency of the crayon results in a crayon that is too soft and therefore does not have the desired features of a crayon that is made by the process as instantly disclosed.

In one embodiment, the composition 100 comprises about 6 tablespoons of tempera or one or more coloring pigments. The precise amount of tempera powder is necessary to create an ideal texture. If less tempera powder is used, the resulting crayon does not deposit enough pigment on paper. If more tempera powder is used, the crayon has a coarse and chalky texture. If less than 3 tablespoons of pigment is used for the whole batch, the pigment color is almost not able to be seen on paper. It was discovered that more than 10-12 tables spoon of pigment makes the consistency too coarse and leaves residue on the paper when coloring. Adding too much or too little of the tempera can cause the crayon texture to change as well as changing the actual color required. Therefore, a feature of the present disclosure is for an exact amount of tempera being used. However, the recipe can be doubled or halved as long as the ratio stays the same.

In one embodiment, the composition 100 comprises a mixture with the ratio of approximately 1 ½ cups soy wax to ¾ cup beeswax to 6 tablespoons tempera powder. In one embodiment, the composition 100 comprises a mixture of about ¼ cups of soy wax to ⅜ cups beeswax to 3 tablespoons tempera powder. In one embodiment, the mixture can be made in any volume with the same ratio of waxes and pigments that is less than the total volume of 1 ½ cups soy wax to ¾ cup beeswax to 6 tablespoons tempera powder. A greater volume of the mixture results in wax at the bottom heating to over 185 degrees Fahrenheit before the mixture is fully melted, resulting in the pigment separating from the wax and not retaining color.

One cup is equivalent to 8 fluid ounces in standard US measurements, or approximately 237 milliliters. In one embodiment, one cup can equal between 230 and 250 milliliters. One tablespoon is equivalent to approximately 14.8 milliliters. In one embodiment, one tablespoon can equal between 12 and 18 milliliters.

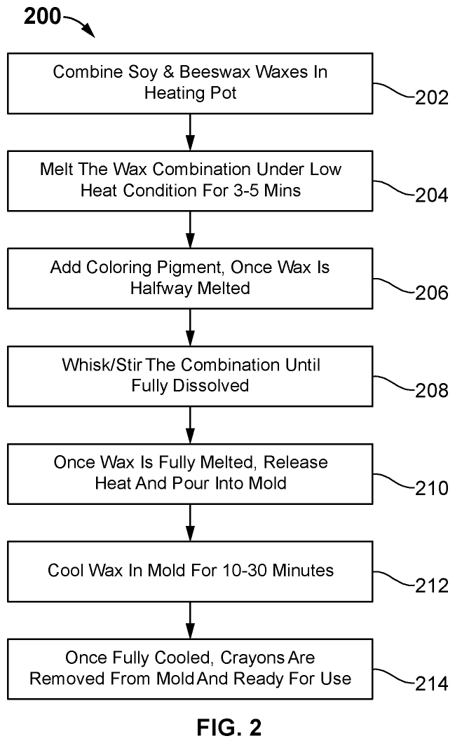

Referring to FIG. 2, a method 200 for producing an eco-friendly crayon comprises the following steps. The crayons may be made in a variety of shapes and sizes, and also in a variety of vibrant colors that appeal to children. At step 202, one or more waxes are combined in a heating pot or heating chamber to form a wax mixture. In one embodiment, the one or more waxes include soy wax and beeswax. In one embodiment, a spatula is used to stir the waxes to form the mixture. At step 204, the wax mixture is melted at a low heat to form a halfway melted mixture. The wax mixture is then heated at the low temperature for a predefined period of time, ranging from about 3 to about 5 minutes. At step 206, a coloring pigment or tempera is added to the halfway melted mixture. The coloring pigment is used for coloring crayons and can be any color.

In one embodiment, the coloring pigment is egg-based tempera powder. The tempera powder is non-toxic and was used as a water-soluble pigment to give the crayon a creamy consistency, improve crayon blendability and give the crayon the ability to be pastel like. The halfway melted mixture and pigment were mixed with a whisk until the mixture was fully melted. The use of a whisk prevents clumps of beeswax from heating unevenly. Other methods of mixing at this state result in clumps of beeswax that were found to prevent the mixture from fully melting which caused problems with pigment separation. Typically, the coloring pigment is one or more vibrant colors that appeal to children and provide bold clear contrast and definition when used on paper.

In one embodiment the tempera pigment comprises a mixture of brown pigment and a small amount of black pigment. It was discovered that when only brown tempera pigment was used, the crayon became too brittle and cracked easily. The addition of black tempera pigment prevented the crayon from becoming more brittle and cracking easily.

When trying the natural tempera pigments, it was found that the pigment color did not hold to the wax as well as tempera. After extensive experimentation it was found that actual natural pigments (not tempera) such as beet juice, turmeric etc. while these do add coloring to the crayons, the process became very time consuming, and one becomes limited on the colors you able to produce. The inventor of the instant application also experimented and used natural tempera pigments such as Rublev natural tempera pigments, however, these pigments are cost prohibitive and are about three times the cost of Coloration's tempera pigment.

The tempera bonds to the wax at a low temperature while other pigments do not hold the bond to the wax. Natural color pigments were also used, such as beet juice, however, these options were overtly time consuming and costly and were limited on the type of colors one was able to use. It was surprisingly found that using Colorations Tempera powder was the most effective, non-toxic and least costly way to produce the instantly disclosed crayons. Other benefits include the fact that a large variety of colors can be made, unlike other existing brands of tempera that had fewer color options and were not certified non-toxic.

At step 208, the halfway mixture with coloring pigment obtained at step 206 is stirred until the mixture is fully dissolved. The heat step is stopped once the melting mixture is completely dissolved. The mixture cannot be overheated. If overheated (over 185 F), the wax and coloring pigment were found to separate, resulting in the melted mixture failing to absorb the coloring pigment. The mixture cannot be overheated because the wax and pigment were found to separate. Once that separation occurred, some of the wax failed to absorb the pigment, leaving it uncolorable. In one embodiment, the mixture is heated at an optimum temperature of between 175 and 185 degrees Fahrenheit to avoid the separation of the wax and coloring pigment. If the temperature of the mixture is below 175 degrees Fahrenheit, the wax mixture did not fully melt and it was not possible to pour the resulting mixture into the molds.

At step 210, the dissolved mixture is poured into a mold. In one embodiment, the heat of the dissolved mixture is released after fully dissolving the mixture and pouring into the mold. At step 212, the mixture that is poured into the mold is left to cool down. In one example, the mixture in the mold is cooled for a period of time, ranging from about 10 minutes to about 30 minutes. In one embodiment, the time required to cool the mixture in the mold varies and this depends on the size and surface area of the mold. In one embodiment, the mixture is cooled in an air-conditioned room. In one embodiment, the mixture is cooled in a refrigerator. If the air temperature of the area in which the mixture is cooled was too warm, the wax was found to remain too soft to be removed from the mold. If the air temperature was too cold, the mixture cooled too rapidly and the resulting crayon broke the mold. At step 214, the cooled mixture is removed from the mold and is then ready for use. In one embodiment, the wax mixture enables the crayon to be softer and be amenable to bending without breakage of the crayon. In one embodiment, the crayon comprises a non-toxic composition used in the above method.

Advantageously, the crayon is an eco-friendly crayon. The crayon comprises a non-toxic composition having the disclosed mix of non-toxic waxes coupled with colored tempera and is used to create handmade non-toxic and eco-friendly crayons in a variety of shapes and sizes. The instantly disclosed wax combination and coloring pigment eliminates the need of any additional ingredients, thereby providing a softer crayon that not only is more amenable to bending and resistant to breakage when compared to existing crayon products, but also one that has superior attributes when it comes to the environment, eco-friendliness and the health of a child's skin.

The present invention provides an eco-friendly, non-toxic crayon free of harmful components and one that prevents crayons from remaining in user's hand by, amongst other disclosed features herein, using soy and beeswax which are eco-friendly materials. Also, the method is used to prepare the non-toxic crayon without additional ingredients typically found in existing crayons, thereby providing a softer crayon that is of superior quality and is eco-friendlier and safer. The crayons could be made of any vibrant colors. Further, the eco-friendly and non-toxic nature of the crayon is a feature of the present disclosure and provides good marketability to the product in view of parents seeking safer and more environmentally conscious crayons for use by their children.

In one embodiment, the composition comprises one or more non-toxic ingredients to prepare eco-friendly crayons. In one embodiment, the one or more non-toxic ingredients include one or more waxes and at least one coloring agent. In one embodiment, the one or more waxes includes soy wax and beeswax. The wax mixture enables the crayon to be softer and operate as a more blendable crayon than other existing products. In one embodiment, the composition comprises about 1 ½ cups of soy wax and about ¾ cup of beeswax. The mixture of soy wax and beeswax acts as a non-toxic and eco-friendly alternative to paraffin wax, a product derived from petroleum. Paraffin wax and colored pigment are traditionally used to create most crayons. Soy and Beeswax were considered by this disclosure as a non-toxic alternative for a crayon base. Beeswax contains none of the harmful chemicals found in Paraffin wax. Paraffin contains several toxic chemicals, including Benzene and Toluene. Paraffin wax is made from petroleum, the same petroleum that is used to make gas. The inventor of the instant application experimented and surprisingly discovered that soy wax and beeswax and in a particular ratio combination provided for superior results. Moreover, this disclosure provided for the added benefit in that soy wax is made from soy bean and bees wax is made by bees, and as such both are natural and provide an eco-friendly option.

At another step, the halfway mixture with coloring pigment is stirred well until the mixture is fully dissolved. In one embodiment, the composition comprises about 6 tablespoons of tempera or coloring pigment. In one embodiment, the heat is taken off upon completely melting the mixture. In one embodiment, the mixture is heated at an optimum temperature to avoid the separation of the wax. At another step, the dissolved mixture is poured/placed into a mold. In one embodiment, the heat of the dissolved mixture is released after fully dissolving the mixture and poured into the mold. At another step, the mixture poured into the mold is cooled.

In one embodiment, the mixture in the mold is cooled for a period of time ranging from about 10 minutes to about 30 minutes. In one embodiment, the time required to cool the mixture in the mold varies depending on the size of the mold. At another step, the cooled mixture is removed from the mold and ready for use. In one embodiment, the wax mixture enables the crayon to be softer and blendable. In one embodiment, the crayon comprises a non-toxic composition used in the above method. In another embodiment, the crayons are made in a variety of shapes and sizes and could be made of any vibrant colors that appeal to children and artists.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A composition for preparing an eco-friendly crayon comprising one or more non-toxic ingredients, soy wax, beeswax, and a coloring pigment.

2. The composition of claim 1, wherein the crayons are made in a variety of shapes and sizes.

3. An eco-friendly crayon comprising a non-toxic composition of claim 1.

4. A method for preparing an eco-friendly crayon, comprising the steps of:
combining one or more waxes in a heating chamber to form a wax mixture comprising soy wax and beeswax;
melting the mixture on a low heat to form a halfway melted mixture;
adding coloring pigment to the halfway melted mixture;
stirring the mixture until fully dissolved;
pouring the dissolved mixture into a mold; and
cooling the mixture in the mold to prepare crayons.

5. The method of claim 4, wherein the wax mixture consists of soy wax and beeswax.

6. The method of claim 4, wherein the wax mixture is heated at a low temperature to form the halfway melted mixture for a predefined period of time ranging from about 3 to about 5 minutes.

7. The method of claim 4, wherein the dissolved wax is cooled for a period of time ranging from about 10 to about 30 minutes.

8. The method of claim 7, wherein the time required for cooling the dissolved wax depends on the size of the mold.

9. The method of claim 4, wherein the crayon is soft and blendable.
